(19) United States
(12) Patent Application Publication
(10) Pub. No.: US 2017/0024472 A1
(43) Pub. Date: Jan. 26, 2017

(54) INFORMATION RETRIEVAL METHOD UTILIZING WEBPAGE VISUAL AND LANGUAGE FEATURES AND SYSTEM USING THEREOF

(71) Applicant: GREEN PRESTIGE PTE. LTD., Singapore (SG)

(72) Inventor: Ting-Chun Peng, Singapore (SG)

(21) Appl. No.: 14/860,984

(22) Filed: Sep. 22, 2015

(30) Foreign Application Priority Data
Jul. 23, 2015 (TW) 104123950

(51) Int. Cl. G06F 17/30

(52) U.S. Cl. CPC G06F 17/30864

(57) ABSTRACT

An information retrieval method utilizing webpage visual and language features and a system using thereof are disclosed. The system includes an analysis result database, a webpage template database, a webpage collecting module, and an analyzing module. The webpage template database stores template feature arrays of respective target websites.

Each of the template feature arrays includes one or more template visual feature and one or more template language feature which are corresponding to template nodes of a DOM tree. The system is linked to a target website by the webpage collecting module, so as to retrieve webpage feature arrays of a target webpage of the target website. The system calculates an overall similarity between the webpage feature arrays and the template feature arrays corresponding to the same target website. Consequently, a desired information content can be determined and stored in the analysis result database.

### CROSS-REFERENCES TO RELATED APPLICATIONS

This non-provisional application claims priority under 35 U.S.C. §119(a) on Patent Application No. 104123950 filed in Taiwan, R.O.C. on 2015 Jul. 23, the entire contents of which are hereby incorporated by reference.

### BACKGROUND

Technical Field

The instant disclosure relates to a webpage information retrieval system, in particular to a system and method utilizing webpage visual and language features.

Related Art

With the spread of internet access and increases in connection speed, e-commerce has gained considerable attention in recent years. For vendors, one of the main challenges is how to attract consumers and encourage them to make purchases. In many instances, merchandise pricing is one of the factors that consumers consider in selecting on-line shopping sites. Consequently, the monitoring of competitor prices is one of the key tasks for e-commerce vendors.

Typically, competitor price monitoring is carried out by someone accessing a competitor's website to search and record product pricing. However, this manual procedure could involve human errors such as misreading or misrecording pricing information, and is very time consuming.

To address the above issue, one current approach is utilizing a web crawler to download contents from a target website, followed by analyzing the contents based on source codes. However, as web development language continues to evolve, such as active scripting by AJAX or Javascript, not all information will be shown when accessing the website. For example, some information will appear only if certain condition(s) is met (e.g., scrolling the mouse wheel, clicking the mouse, moving the cursor over certain location). In those cases, the target information cannot be obtained even through the source codes.

The above issue does not apply only to price monitoring only, but also happens if someone wants to retrieve some information from any other websites that use active scripting or the template of them cannot be identified precisely using only language features.

### SUMMARY

To address the above issue, the instant disclosure provides an information retrieval system and method utilizing webpage visual and language features, to retrieve webpage information efficiently with precision, especially for webpages that use active scripting.

In one embodiment, the instant disclosure provides an information retrieval system utilizing webpage visual and language features. The system comprises an analysis result database, a webpage template database, a webpage collecting module, and an analyzing module. The webpage template database stores at least one template feature array of at least one target website. The array include at least one visual feature and at least one language feature of at least one template node in the document object model (DOM) data structure. The webpage collecting module links with the target website, retrieves at least one visual feature and at least one language feature from at least one webpage node of at least one target webpage of the target website, and forms at least one webpage feature array. The analyzing module calculates the overall similarity between the webpage feature array and template feature array for the same target website. If the overall similarity is greater than a threshold value, the contents of the webpage node are saved in the analysis result database.

In another embodiment, the instant disclosure provides an information retrieval method utilizing webpage visual and language features. The method comprises the steps of: storing at least one template feature array of at least one target website, with the array including at least one visual feature and at least one language feature of at least one template node in the DOM data structure; linking with the target website to retrieve at least one visual feature and at least one language feature of at least one webpage node of at least one target webpage of the target website and form at least one webpage feature array; calculating an overall similarity between the webpage feature array and template feature array for the same target website; and storing the contents of the webpage node in an analysis result database if the overall similarity is greater than a threshold value.

Based on the above, the information retrieval system and method of the instant disclosure can identify target information from webpages that use active scripting. In addition, the utilization of visual and language features enables identification of the target information with more precision.

### BRIEF DESCRIPTION OF THE DRAWINGS

FIG. 1 is a block diagram of an information retrieval system for a first embodiment of the instant disclosure.

FIG. 2 shows a webpage template displaying feature arrays for the first embodiment of the instant disclosure.

FIG. 3 shows a shopping webpage for the first embodiment of the instant disclosure.

FIG. 4 is a flow chart showing the steps of an information retrieval method of the instant disclosure.

FIG. 5 is a block diagram of an information retrieval system for a second embodiment of the instant disclosure.

FIG. 6 shows the creation of nodes on a webpage template for the second embodiment of the instant disclosure.

FIG. 7 shows pre-filtering the nodes on a webpage for a third embodiment of the instant disclosure.

FIG. 8 shows the element nodes of a news webpage for one embodiment of the instant disclosure.

FIG. 9 shows the element nodes of a government webpage for one embodiment of the instant disclosure.

### DETAILED DESCRIPTION

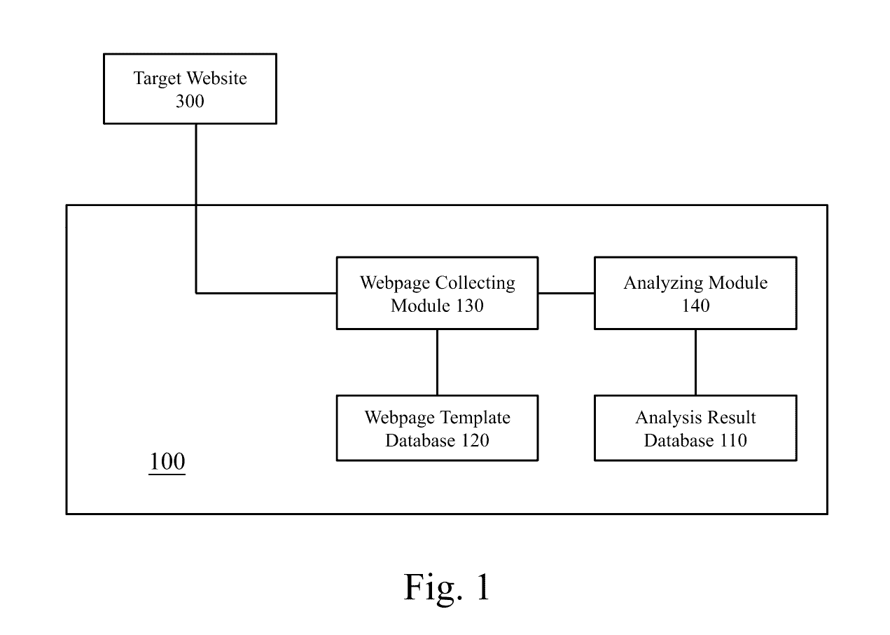

Please refer to FIG. 1, which shows an information retrieval system 100 utilizing webpage visual and language features for a first embodiment of the instant disclosure. The system 100 comprises an analysis result database 110, a webpage template database 120, a webpage collecting module 130, and an analyzing module 140. This system 100 can link with multiple target websites 300 and automatically retrieve information from each target website 300.

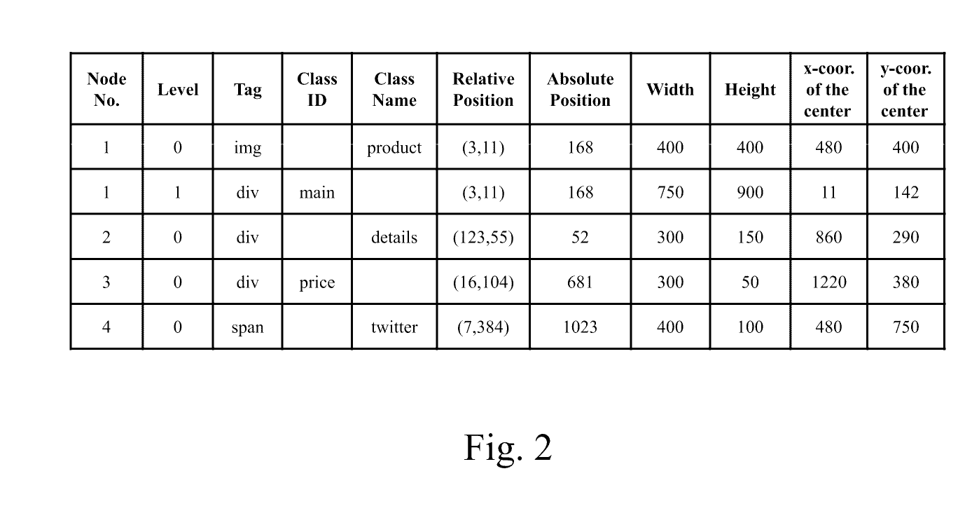

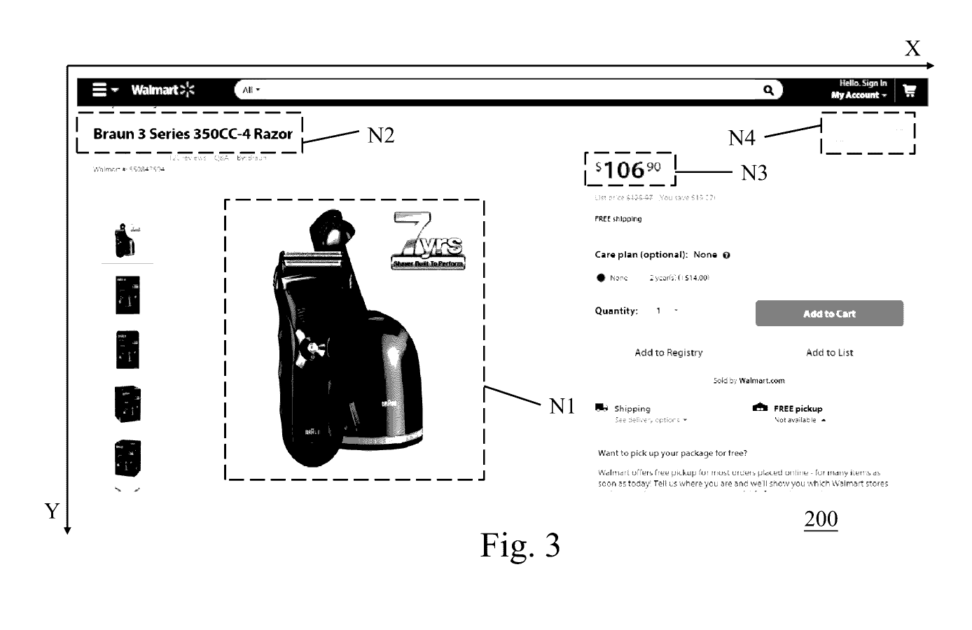

For this embodiment, the target website 300 is taken as an on-line shopping site for exemplary purposes. FIG. 2 shows an example of template feature arrays corresponding to the shopping website. Please also refer to FIG. 3, which shows a product webpage 200 of a shopping website for the first embodiment. Typically, for different websites, the webpages are designed differently, such that the product names, pictures, pricing information, etc., may be different in size, location, color, etc. Nevertheless, for each target website 300, the webpages are normally presented in the same or a similar manner. Based on this design approach, the webpage template database 120 can store corresponding template feature arrays according to the type of the website. In other words, the webpage template database 120 stores multiple template feature arrays in accordance to different target websites 300. Based on these stored arrays, information associated with the corresponding websites can be retrieved.

In conjunction with FIGS. 2 and 3, the stored arrays include at least one visual feature and at least one language feature of the template nodes in the DOM (Document Object Model) tree data structure. For the instant embodiment, as shown in FIG. 2, the webpage template database 120 stores the visual and language feature arrays associated with four template nodes N1˜N4 shown in FIG. 3. The language features include node number, hierarchy, tag, class ID, and class name. The node number is designated by the information retrieval system 100 of the instant disclosure, and hierarchy refers to the node hierarchy. The tag refers to its characteristics such as tag name, image source, hyperlink, etc. Class ID and class name are used by the Cascading Style Sheets (CSS) language. The relative position refers to the node hierarchy and the serial number of the node within its hierarchy in the DOM tree structure (for the instant embodiment, node N1 resides at the third level of the tree and is the11^{t}h node indexing from the left). The absolute position refers to the overall sequence number of each node (i.e., N1˜N4) in the DOM tree (for the instant embodiment, node N1 is the 168^{th} node in the DOM tree indexing from a top to bottom direction). Meanwhile, the visual features include width, height, and the x- and y-coordinates of the center. The widths and heights refer to the width and height of the image region of each node shown on the webpage, respectively. With the upper left-hand corner of a webpage being the starting point, the x- and y-coordinates are the horizontal and vertical addresses for the center of the node region shown on the webpage, respectively. It should be noted that the coordinate system does not have to use the upper-left hand corner as the starting point. Other locations such as the center or upper-right hand corner of the webpage may be chosen as well. It should be understood that the feature array is a sparse matrix in which some elements do not contain any information.

The above elements of the visual and language features are only for exemplary purposes and are not limited thereto. Other parameters may be included, or only some of the aforementioned parameters selected. For example, the language features may include other CSS characteristics (e.g., text size, color, background color, alignment, Z-index), number of child nodes (i.e., all of the child nodes in the hierarchy under the parent node), Javascript characteristics (e.g., onclick and onsubmit events), etc.

As shown in FIG. 3, the exemplary template of the shopping website needs to monitor for any update regarding the information associated with nodes N1˜N4. Specifically, node N1 is the product picture, node N2 is the product description (e.g., name, model number, description), node N3 is product pricing, and node N4 is a link to another website. In other embodiments, the target nodes are not restricted to contain abovementioned information. That is to say the nodes may include additional information other than the ones mentioned hereinabove. Another configuration may be to exclude some of the aforementioned information, such as omitting the link to another website, paying attention to the product name and model number only without product description, or focusing on the product's actual prices (e.g. discount price), rather than the standard price.

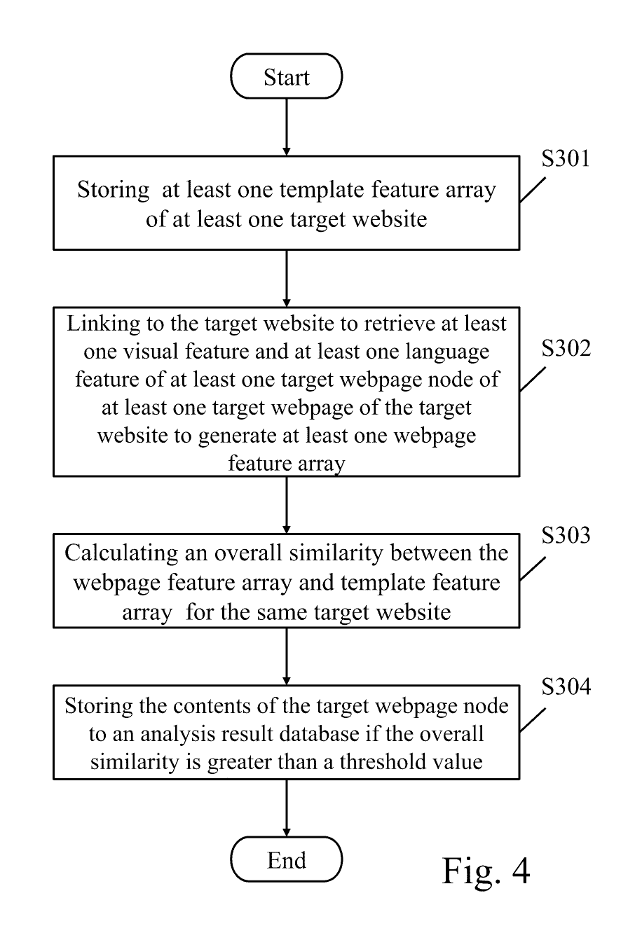

Please proceed to FIG. 4, which shows a flow chart of the information retrieval method utilizing webpage visual and language features for the first embodiment of the instant disclosure. In step S301, the template feature arrays for the target template nodes are saved in the webpage template database 120. As mentioned earlier, these arrays correspond to respective target websites 300.

Next, in step S302, the webpage collecting module 130 links to at least one of the target websites 300, retrieves at least one visual feature and at least one language feature from at least one node of at least one target webpage, and generates at least one webpage feature array. The webpage collecting module 130 is equipped with the web crawler capable of retrieving information from the target website 300, where the retrieved information comprises webpage visual and language features. The types of webpage visual features are identical to the template visual features described earlier. For the purpose of distinguishing from template feature arrays, the visual features of a webpage retrieved by the webpage collecting module 130 are called “webpage visual features” herein. In other words, the webpage visual features are visual features retrieved from the monitored and analyzed webpage, while the template visual features are visual features stored in the webpage template database 120. Similarly, the language features of a webpage retrieved by the webpage collecting module 130 from the target website 300 are referred to as “webpage language features”, with same types of parameters as the template language features. In other words, the feature arrays of the webpage of the target website 300 retrieved by the webpage collecting module 130 have same types of parameters as the template feature arrays stored in the webpage template database 120. The webpage language features are language features retrieved from the monitored and analyzed webpage, while the template language features are language features stored in the webpage template database 120. Both of the template nodes and webpage nodes are nodes within the DOM tree data structure. More specifically, the template nodes are nodes of the template feature arrays, while the webpage nodes are nodes of the webpage feature arrays.

In the next step S303, the analyzing module 140 calculates an overall similarity between the webpage feature arrays of the target website 300 and the corresponding template feature arrays. More specifically, the analyzing module 140 can calculate a first similarity score between the webpage language features of the target website 300 and the corresponding template language features, in addition to calculating a second similarity score between the webpage visual features and the template visual features. Next, a weighted method is applied to the first and second similarity scores to obtain the overall similarity. Consequently, multiple first similarity scores can be calculated based on multiple properties of the webpage language features (template language features). Similarly, multiple second similarity scores can be calculated based on multiple properties of the webpage visual features (template visual features). These first and second similarity scores are weighted to obtain the overall similarity, such as by multiplying each of the first and second similarity scores by a weighting constant, and finding the sum of these products.

For example, if the second similarity score is calculated based on height and weight, equation [1] shown below can be used but is not restricted thereto. If the x and y addresses of the center coordinates are referenced instead, equation [2] shown below may be utilized but is not restricted thereto.

second similarity score=1/(width difference+height difference+1), where the width difference and the height difference refer to the difference in width and height between the template feature array and webpage feature array, respectively. [1]

second similarity score=1/(difference in x-coordinates+difference in y-coordinates+1), where the differences in x and y coordinates refer to the differences in x and y addresses of the center coordinates between the template feature array and webpage feature array, respectively. [2]

For calculating the first similarity score, there are basically two approaches. Namely, for value-based properties such as relative position, absolute position, and number of child nodes, the cosine similarity algorithm may be used but is not restricted thereto. For text-based properties like Class ID, Class Name, color, and hyperlink, Jaccard similarity or Levenshtein distance may be utilized, but is not restricted thereto.

In the final step S304, if the overall similarity surpasses a threshold value, the analyzing module 140 stores the contents (properties), of the webpage node into the analysis result database 110. The threshold value may be a predetermined value, which can be adjusted according to previous similarities. Consequently, the analysis result database 110 can be accessed to obtain the target content (e.g., price change), of the shopping website. In the case of overall similarity between node A of a target webpage and node B of the template database 120, the higher the value, the greater possibility that node A and node B are the same node such as product name.

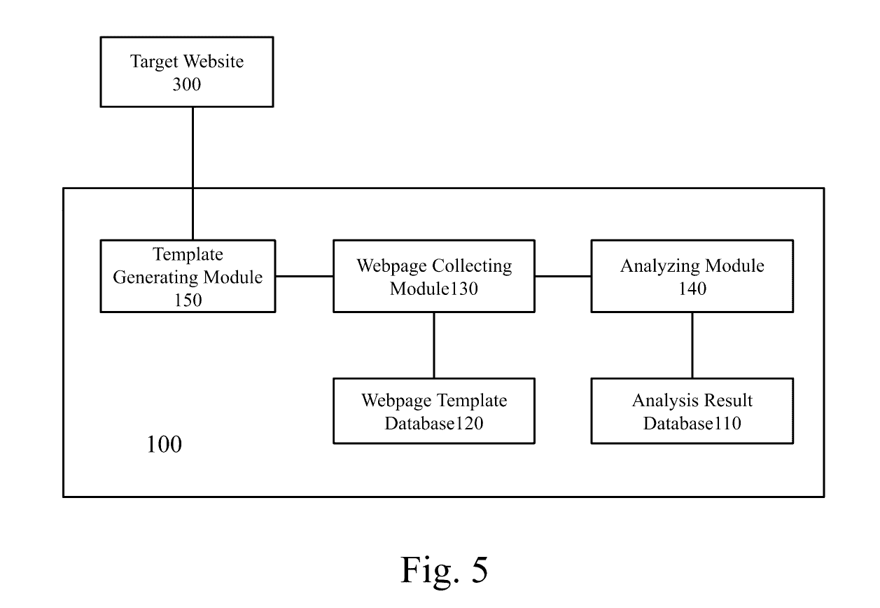

Please refer to FIG. 5, which shows the information retrieval system 100 utilizing webpage visual and language features for a second embodiment of the instant disclosure. In comparing to the first embodiment, the present embodiment further comprises a template generating module 150. The template generating module 150 can analyze the source codes of the target website's webpage to identify various nodes within the DOM structure, and retrieve at least one visual feature and at least one language feature of each node.

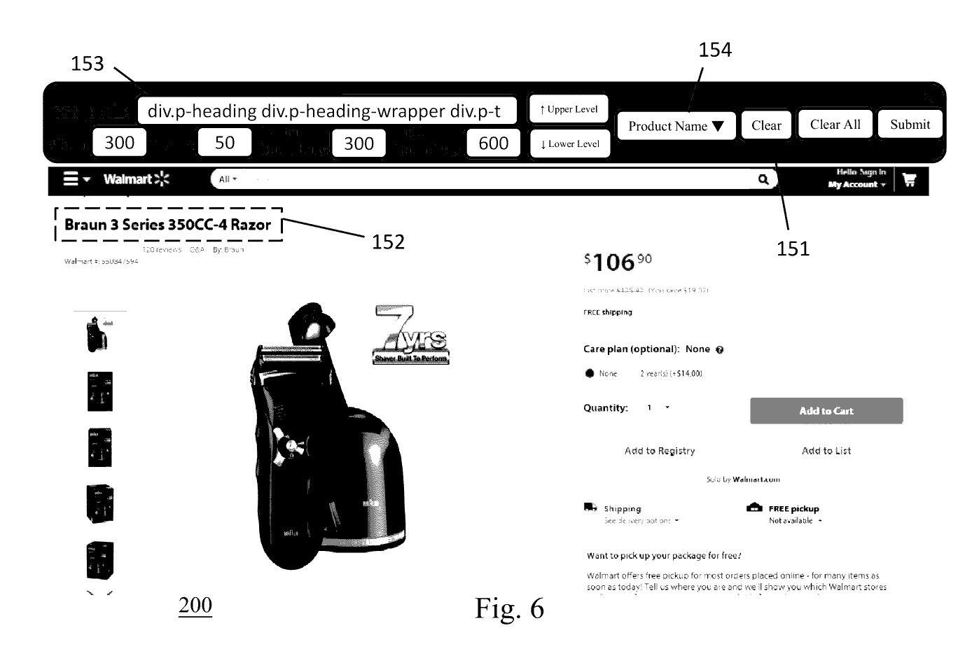

Please refer to FIG. 6, which shows the node creation of the instant embodiment.

The node generating module 150 provides a selecting interface 151 shown on the upper region of the product webpage 200. The interface 151 lets the user select an element node such as 152 from a list as the template node (N1˜N4). In this embodiment, the element node 152 of product name is chosen as the template node N2 as an example. The interface 151 further includes multiple information bars 153 for presenting relevant information (e.g., template visual and language features), such as specified CSS selectors of the element node 152 like path, width, height, upper boundary, lower boundary, etc. Furthermore, the interface 151 includes a plurality of control elements 154. Based on a drop-down list or selection buttons, the control elements 154 allow the user to view the information associated with an upper or lower level of the element node (e.g., by clicking the “upper level” or “lower level” button). Moreover, the control elements 154 let the user decides what the element node represents. For instance, the user can set the current element node is for the product name by manipulating a drop-down menu. By clicking “clear”, the user may also delete the setting of the current element node via the control elements 154. By clicking “clear all”, the user may clear all previous settings. By clicking “submit”, the user can save the current setting in the template database 120.

In this way, for the instant embodiment, before step S301 of FIG. 4, the template generating module 150 can be used to analyze the element nodes 152 of the webpages associated with target websites 300, in order to retrieve at least one visual feature and at least one language feature of each element node 152. As mentioned earlier, the template generating module 150 can provide an interface 151 to let the user chooses an element node from a list as the template node. Through this selection process, the specific condition(s) (e.g., scrolling the mouse wheel, clicking the mouse, moving the cursor over a certain region), for providing complete information from an active scripting (e.g., AJAX,

Javascript), webpage can be satisfied, so as to retrieve at least one template visual feature and at least one template language feature.

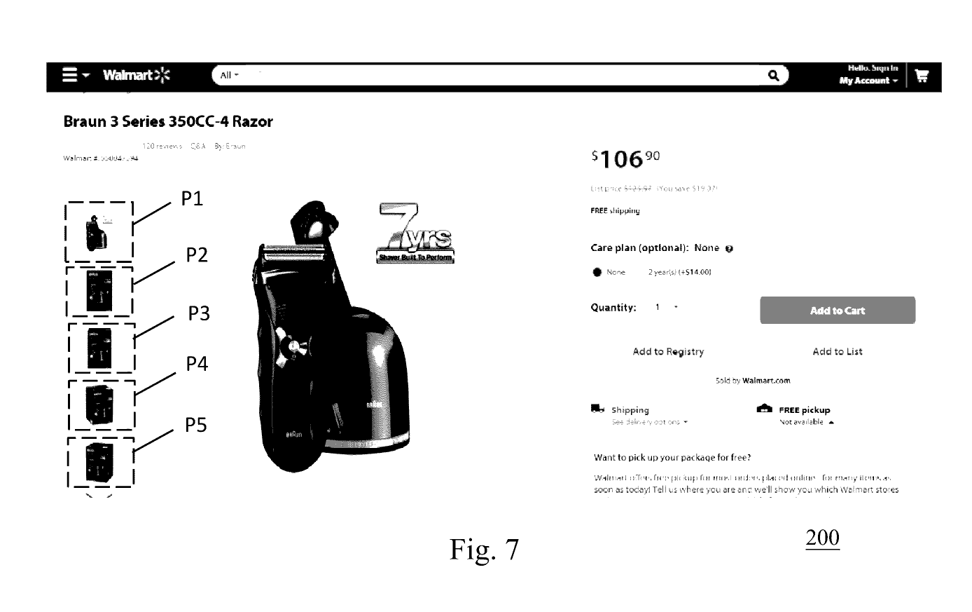

In another embodiment, before step 5303 shown in FIG. 4, that is prior to calculate the overall similarity by the analyzing module 140, the webpage nodes can be pre-filtered based on the template visual features like width and height. For this third embodiment, FIG. 7 provides a schematic view of pre-filtering the webpage nodes. The product webpage 200 may include multiple product photos like photos P1˜P5 shown on the left-hand side of the figure. However, these photos are only recommended products and are not target products for analysis. Therefore, a comparison of information such as widths and heights can first be made between the product photos and the template visual features. If the comparison shows little similarity, the element nodes can be ignored. The comparison can be done by utilizing aforementioned eq. [1] and comparing the second similarity score to another threshold value. If the second similarity score is lower than the threshold value, the element node can be ignored. Otherwise, step S303 is carried out next. Based on the abovementioned approach, the number of element nodes 152 to be evaluated for similarity test in step S303 can be reduced.

The abovementioned information retrieval method of various embodiments can be carried out by the described information retrieval systems 100. The system 100 can be a computer system (e.g., desktop computer, server, etc.), that includes a central processor, north and south bridges, volatile memory, storage unit, internet chip, and other electronic components. The storage unit may be redundant array of independent disks (RAID), just a bunch of disks (JBOD), or a volatile memory device such as a hard disk drive (HDD). The storage unit may accommodate the analysis result database 110 and webpage template database 120, while the webpage collecting module 130, analyzing module 140, and template generating module 150 are software applications stored in the storage unit and operable by the central processor to perform specific tasks.

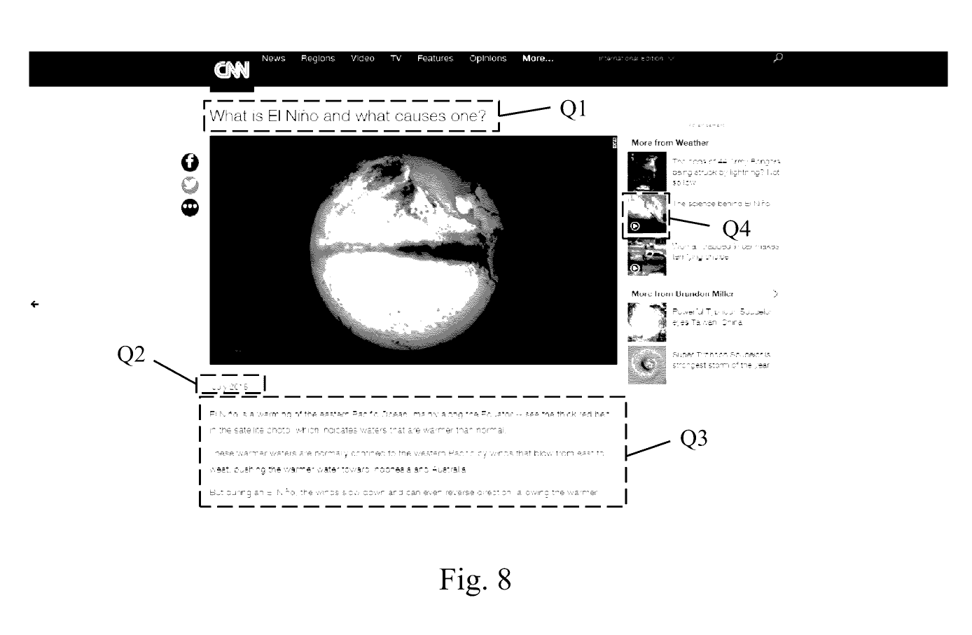

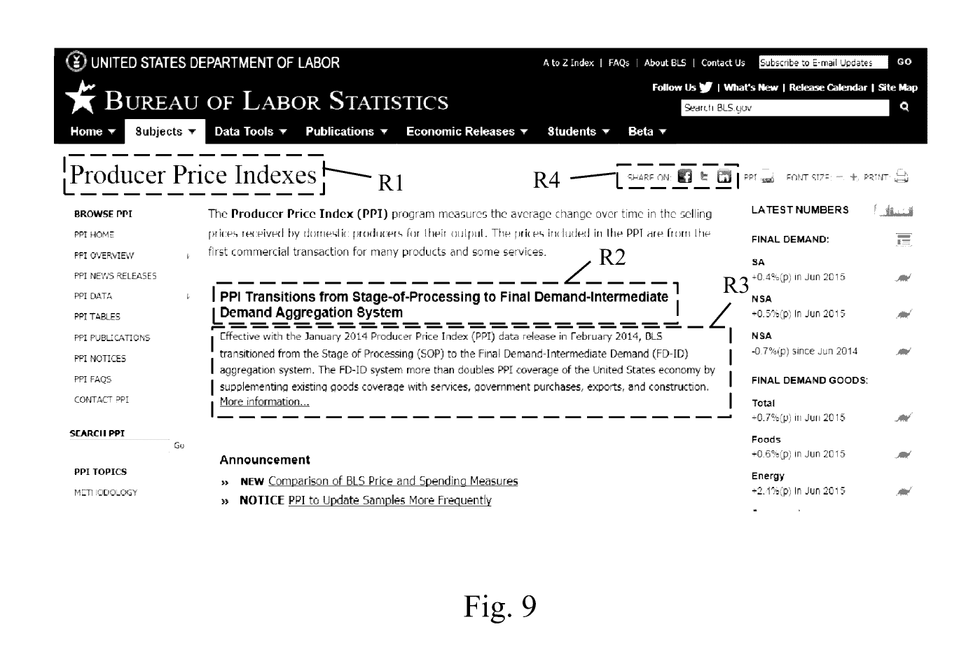

Based on the above, the information retrieval system and method utilizing webpage visual and language features are capable of finding target information from a webpage developed by active scripting. By being able to integrate visual and language features, the target webpage information could be identified more precisely. Although shopping websites are used as an example in the instant disclosure, the disclosed system and method are applicable to other types of websites, such as blogging, news (FIG. 8), and government (FIG. 9), websites. For the news and government websites, the element nodes Q1˜Q4 and R1˜R4 can be monitored, respectively, such that they can be further processed for purposes like statistical analysis and investigation.

While the instant disclosure has been described by way of example and in terms of the preferred embodiments, it is to be understood that the instant disclosure needs not be limited to the disclosed embodiments. For anyone skilled in the art, various modifications and improvements within the spirit of the instant disclosure are covered under the scope of the instant disclosure. The covered scope of the instant disclosure is based on the appended claims.

What is claimed is:

1. An information retrieval system utilizing webpage visual and language features, comprising:
an analysis result database;
a webpage template database for storing at least one template feature array of at least one target website, the template feature array include at least one visual feature and at least one language feature of a template node in the document object model (DOM) data structure;
a webpage collecting module linking with at least one target website, to retrieve at least one visual feature and at least one language feature from at least one target webpage node of at least one target webpage of the target website in forming a corresponding webpage feature array; and
an analyzing module to calculate an overall similarity between the webpage feature array and the template feature array for the same target website, if the overall similarity being greater than a threshold value, the analysis result database stores the contents of the corresponding target webpage node.

2. The system of claim 1, further comprising a template generating module for analyzing at least one element node of at least one target webpage of at least one target website, retrieving at least one visual feature and at least one language feature of the element node, and providing a selection interface to designate the element node as the template node.

3. The system of claim 1, wherein the template visual feature is of width and height information, and the analyzing module pre-filters the target webpage node based on the width and height information prior to calculate the overall similarity.

4. The system of claim 1, wherein the analyzing module calculates a first similarity score between the webpage language feature and template language feature and a second similarity score between the webpage visual feature and template visual feature for the same target website and calculates the overall similarity based on the weighted first and second similarity scores.

5. An information retrieving method utilizing webpage visual and language features, comprising:
storing at least one template feature array of at least one target website, with the template feature array including at least one visual feature and at least one language feature of a template node in the document object model (DOM) data structure;
linking with the target website to retrieve at least one visual feature and at least one language feature of at least one target webpage node of at least one target webpage in forming a corresponding webpage feature array;
calculating an overall similarity between the webpage feature array and template feature array for the same target website; and
storing the contents of the webpage node in a analysis result database if the overall similarity being greater than a threshold value.

6. The method of claim 5, further comprising:
analyzing at least one element node of at least one target webpage of at least one target website to retrieve at least one visual feature and at least one language feature of the element node; and
providing a selecting interface to designate the element node as the template node.

7. The method of claim 5, wherein the template visual feature is of width and height information and prior to calculate the overall similarity, the method further includes pre-filtering the target webpage node based on the width and height information.

8. The method of claim 5, wherein for calculating the overall similarity between the webpage feature array and template feature array for the same target website includes:
calculating a first similarity score between the webpage language feature and template language feature for the same target website;
calculating a second similarity score between the webpage visual feature and template visual feature for the same target website; and
calculating the overall similarity by weighting the first and second similarity scores.
